(19) United States
(12) Patent Application Publication
(10) Pub. No.: US 2015/0107784 A1
(43) Pub. Date: Apr. 23, 2015

(54) METHOD FOR PRODUCING A WINDING DEVICE AS WELL AS WINDING DEVICE

(71) Applicant: Ferdinand Braselmann GmbH & Co. KG, Ennepetal (DE)

(72) Inventor: Thomas VOIGT, Ennepetal (DE)

(73) Assignee: Ferdinand Braselmann GmbH & Co. KG, Ennepetal (DE)

(21) Appl. No.: 14/518,068

(22) Filed: Oct. 20, 2014

(30) Foreign Application Priority Data
Oct. 21, 2013 (DE) 10 2013 017 380.9

(51) Int. Cl. E06B 9/42; B21D 11/10; B23K 26/20; E06B 9/68

(52) U.S. Cl. CPC E06B 9/42; E06B 9/68; B21D 11/10; B23K 26/20
USPC 160/133; 72/368; 72/365.2

(57) ABSTRACT

A method for producing a winding device for interconnected slats of a roller shutter, in which a sheet of metal having a pre-determinable length, width and thickness will be provided, seen over the length of the sheet of metal, with an eyelet formed out of the sheet of metal, and the sheet of metal, seen over the length of the sheet of metal, will be bent into the circumferential direction such that a contour is formed that differs from the cylindrical shape and the longitudinal edge of the sheet of metal, which is located opposite the eyelet, will take its bearing in the area of the eyelet, wherein, seen over the length of the sheet of metal, the marginal region of the longitudinal edge will be connected to the eyelet by welding.

The invention relates to a method for producing a winding device for interconnected slats of a roller shutter.

In DE 298 21 589 U1, a roller shutter is disclosed comprising a winding shaft, on which circularly contoured supporting rollers are fixed in a torque-proof manner, and a roller shutter curtain composed of a plurality of slats that are interconnected in an articulated way, which roller shutter curtain is attached to the winding shaft and rests upon the supporting rollers when wound up. At least a part of the supporting rollers comprises a lug extending counter the winding direction, which lug projects beyond the last slat with respect to the thickness thereof, wherein the lug is positioned directly above the top edge of the last slat if the roller shutter curtain is in the unwound position.

DE 10 2006 018 637 relates to a door, especially a high-speed door, at least comprising a door curtain, a door drive and a winding device that is formed as a cylinder which comprises a spiral cross section having a gradient corresponding to the thickness of the belt.

DE 10 2009 004 976 B4 relates to a roller shutter installation comprising a curtain which can optionally be wound up on a winding shaft and be unwound from this one against the balancing force of a weight counterbalance that acts upon the winding shaft in dependence on the portion of the curtain unwound from the winding shaft, and comprising a shaft drive which is in driving connection with the winding shaft as well as a door control for controlling the shaft drive, which door control determines the power input required for uprolling and unrolling the curtain, in order to interrupt the shaft drive if a detected actual value of the power input differs from a determined target value.

It is the object of the invention to provide a method for producing a winding device for interconnected slats of a roller shutter, by means of which method a winding device is designed which is able to reduce hitherto unavoidable impacts which occur during the upwinding and unwinding of the slat elements on the winding device.

Furthermore, a winding device shall be provided which has got a simple structure and by means of which the otherwise complex buffer stop of the slat elements on the winding device can be simplified.

This aim is achieved by a method for producing a winding device for interconnected slats of a roller shutter, in which a sheet of metal having a pre-determinable length, width and thickness will be provided, seen over the length of the sheet of metal, with an eyelet formed out of the sheet of metal, and the sheet of metal, seen over the length of the sheet of metal, will be bent into the circumferential direction such that a contour is formed that differs from the cylindrical shape and the longitudinal edge of the sheet of metal, which is located opposite the eyelet will take its bearing in the area of the eyelet, wherein, seen over the length of the sheet of metal, the marginal region of the longitudinal edge will be connected to the eyelet by welding.

Advantageous embodiments of the subject of invention are disclosed in the associated method sub-claims.

The aim is also achieved by a winding device for uprolling and unrolling interconnected slats of a roller shutter, comprising a winding tube made of a sheet of metal and produced by rolling or bending, which winding tube comprises a contour that differs from the cylindrical shape as well as an eyelet formed out of one of the longitudinal edges of the sheet of metal.

Advantageous embodiments of the winding device according to the invention are disclosed in the associated device sub-claims.

The longitudinal edge of the sheet of metal, which is located opposite the eyelet, is advantageously connected to the eyelet by means of laser welding.

The tube provided with a non-round shaped cross section is preferably provided with a drive axis that is eccentrically placed therein and located in at least the end portions of the winding tube with respect to the same one.

While in the state of the art several slats have to be provided on the circumference of the respective winding device, in order to assure a safe winding up of the entire slat stack on the winding tube, the subject of invention provides the eyelet as reception body for the last slat facing the eyelet. Thanks to this measure alone, numerous slats that are no more required can be saved.

The last slat of the slat stack facing the eyelet is provided with a connection and guide element (advantageously over the entire length of the slat), which is inserted into the eyelet during manufacture.

Should damages occur on individual slats of the slat stack, the entire roller shutter installation would have to be dismounted and disassembled in a time-consuming and costly way.

In this context, it is alternatively useful to introduce the last slat of the slat stack from the front into the eyelet by pivoting via so called clip elements, in order to connect the last slat actively to the winding device. If individual or several slats of the slat stack are damaged, this one or these ones can then be detached from the winding device of the roller shutter in a simple way and after replacement of the damaged element(s) it/they can be reconnected as easily to the winding device.

Thanks to the intentionally non-round contour of the tubular winding device, impacts that occur during upwinding and unwinding of the slats are reduced to the greatest possible extend. As a result of the reduced impacts that occur during upwinding and unwinding of the slats of the slat stack, the entire drive of the roller shutter can also be designed with smaller dimensions, since it becomes possible to work with average torques instead of maximum torques for calculating the driving power required for upwinding and unwinding the slats of the slat stack.

The subject of invention is represented in the drawing by means of an exemplary embodiment and described as follows. Herein:

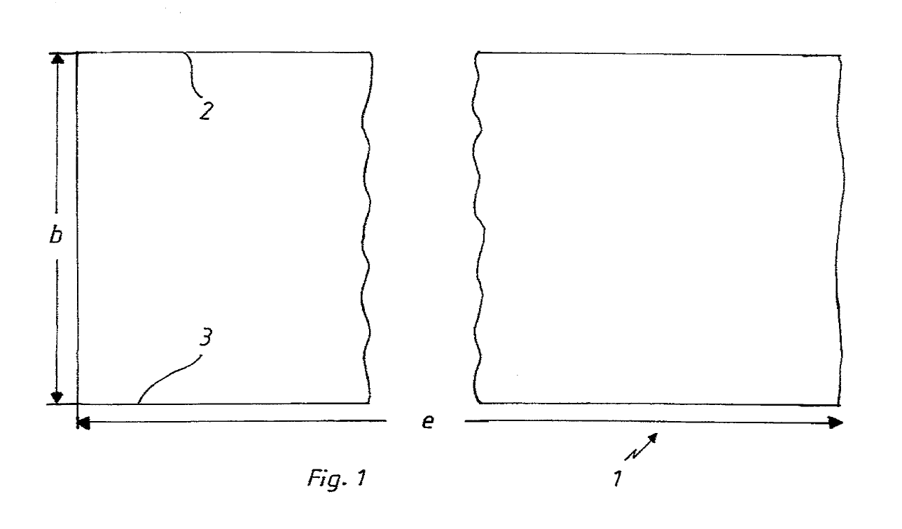

FIG. 1 is a schematic diagram of the starting material of the winding device according to the invention;

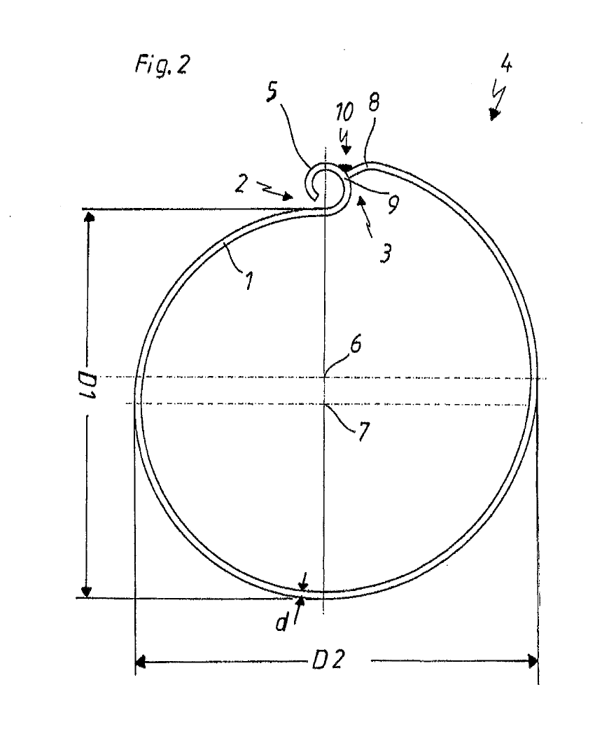

FIG. 2 shows a cross section of the finished state of the winding device according to FIG. 1;

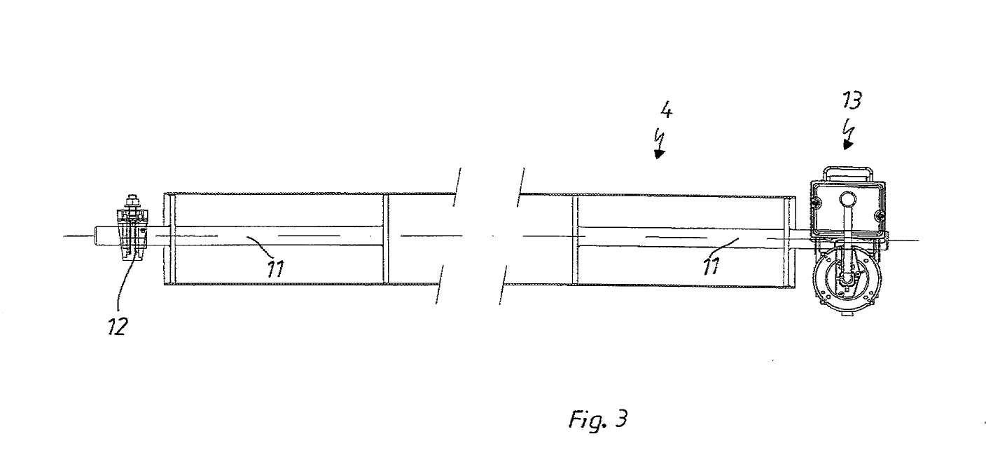

FIG. 3 is a schematic diagram of the winding device according to FIG. 2, complemented by bearing and drive elements;

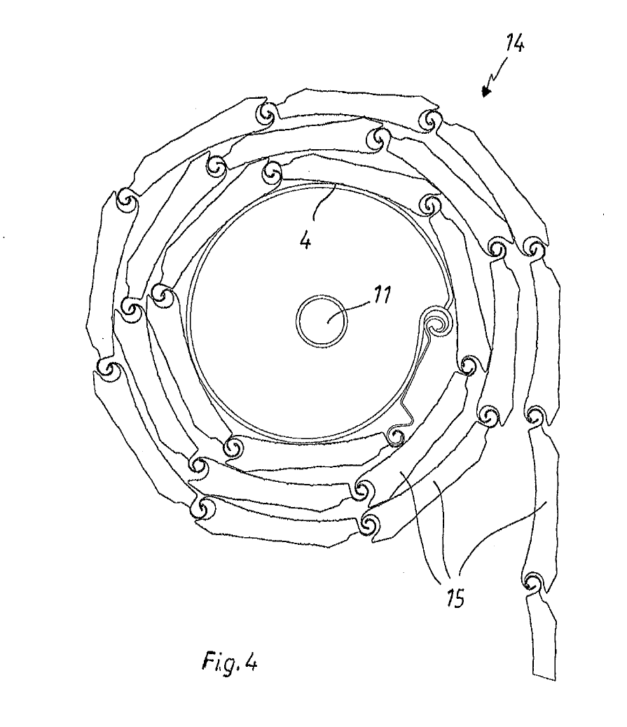

FIG. 4 is a cut through a wound up slat stack;

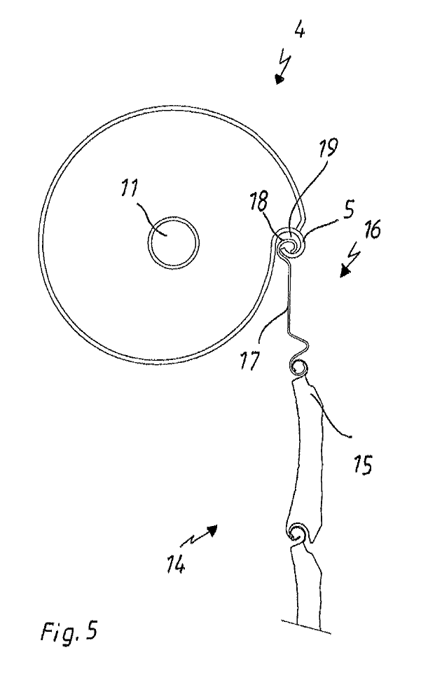

FIG. 5 is a partial view of the suspension of the slat stack according to FIG. 4:

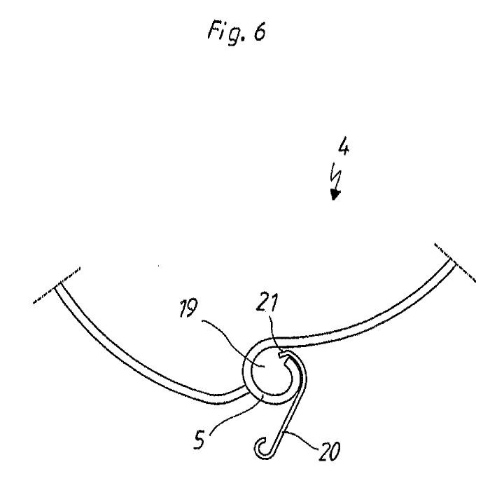

FIG. 6 is an alternative partial view of the suspension of the slat stack according to FIG. 4.

FIG. 1 is a schematic diagram showing the starting material of the winding device according to the invention. A sheet of metal 1 having a pre-determinable length I and width b is represented. The sheet of metal 1 can be for example made of structural steel or the like. The man skilled in the art will determine the selection of material for the respective roller shutter on the base of the given parameters. In a subsequent working step, an eyelet which is not represented here will be formed in the area of one of the longitudinal edges 2, 3 of the sheet of metal 1.

FIG. 2 shows the finished state of the winding device 4 that has been formed from the sheet of metal 1 according to FIG. 1. In this example, an eyelet 5 shall be formed, seen over the length I of the sheet of metal 1, on the longitudinal edge 2 of the sheet of metal 1 which comprises a pre-determinable material thickness d. The other longitudinal edge 3 of the sheet of metal 1 is folded into the direction of the eyelet 5 while producing a cross section that differs from the cylindrical shape. As indicated in FIG. 2, two different diameters are thus produced, namely D1 and D2, which also entails two different centers 6, 7 of the winding device 4. In the course of the winding operation, a linearly extending section 8 is formed on the longitudinal edge 3 which runs towards a definable section 9 of the eyelet 5 and fits closely to this one essentially in a tension-free manner or with internal stress.

Seen over the length of the winding device 4, a welded connection (e.g. by laser welding) 10 is produced between the sections 8 and 9 and thus a firm connection is established.

FIG. 3 is a schematic diagram showing the winding device 4 according to FIG. 2. A traversing drive axis 11, bearing areas 12 which are provided laterally outside the winding device 4 as well as drive means 13 which are also provided laterally of the winding device 4 are visible. During the upwinding of the here not yet visible slats on the winding device 4 maximum upwinding torques occur in some areas if the slats are upwound or unwound, which maximum upwinding torques are the base for dimensioning the drive means 13. As a result of the cross section profile of the winding device 4 according to the invention, which cross section profile differs from the cylindrical shape and comprises different centers 6 and 7, the respective drive axis 11 can be correspondingly provided in a decentralized way between the centers 6 and 7 of the winding device 4. Thanks to this measure, the maximum torques that occur can be reduced, which finally has also a positive effect on the dimensioning of the drive means 13.

FIG. 4 shows a cut through an upwound slat stack 14 formed by a plurality of individual slats 15. The winding device 4 according to the invention including the drive axis 11 thereof is visible.

FIG. 5 is a partial view of the suspension 16 of the slat stack 14. The winding device 4 according to the invention including the drive axis 11 thereof is visible. A hook-shaped connection element 17 extends between the last slat 15 of the slat stack 4, which slat 15 is facing the winding device 4, and the eyelet 5 of the winding device 4, which hook-shaped connection element has a length corresponding to the one of the slats 15. The end portion 18 of the element 17, which end portion is facing the eyelet 5, comprises a corresponding contour which enables to insert the end portion 18 from the side into the clearance 19 of the eyelet 5.

FIG. 6 shows an alternative with respect to FIG. 5, which can be for example useful in case of repair works on damaged individual slats (not represented here). Several connection and guide elements 20 (clips) which can be actively connected to the last slat 15 facing the winding device 4, are used, which connection and guide elements can be inserted from the front into the clearance .19 of the eyelet 5. The end portion 21 of the connection and guide element 20 facing the winding device 4 is hook-shaped herein.

### LIST OF REFERENCE NUMERALS

1 sheet of metal
2 longitudinal edge
3 longitudinal edge
4 winding device
5 eyelet
6 center
7 center
8 section
9 section
10 welding connection
11 drive axis
12 bearing area
13 drive means
14 slat stack
15 slat
16 suspension
17 connection element
18 end portion
19 clearance
20 guide element
21 end portion
l length
b width
d thickness
D1 diameter
D2 diameter

1. A method for producing a winding device (4) for interconnected slats (15) of a roller shutter, in which a sheet of metal (1) having a pre-determinable length (l), width (b) and thickness (d) will be provided, seen over the length (l) of the sheet of metal (1), with an eyelet (5) formed out of the sheet of metal (1), and the sheet of metal (1), seen over the length (l) of the sheet of metal (1), will be bent into the circumferential direction such that a contour is formed that differs from the cylindrical shape and the longitudinal edge (3) of the sheet of metal (1), which is located opposite the eyelet (5) will take its bearing in the area of the eyelet (5), wherein, seen over the length (l) of the sheet of metal (1), the marginal region of the longitudinal edge (3) will be connected to the eyelet (5) by welding (10).

2. The method according to claim 1, wherein the contour of the sheet of metal (1) will be produced by rolling or bending.

3. The method according to claim 1, wherein the eyelet (5) is connected to the marginal region of the longitudinal edge (3) by means of laser welding.

4. The method according to claim 1, wherein the winding device (4) encloses a traversing drive axis (11) that is located in at least the end portions of the winding device (4) with respect to the same one, wherein the drive axis (11) adopts a pre-determinable not centered position with respect to the winding device (4).

5. The method according to claim 1, wherein a connection and guide element (17) is provided at the free end of the slat (15) of the slat stack (14), which slat (15) is the most proximate to the winding device (4), which connection and guide element (17) is inserted laterally into the eyelet (5) of the winding device.

6. The method according to claim 1, wherein, seen over the length of the slats (15), several clip-like elements (20) are provided at the free end of the slat (15) of the slat stack (14), which slat (15) is the most proximate to the winding device (4), which clip-like elements (20) are inserted from the front into the eyelet (5) of the winding device (4) by pivoting.

7. A winding device for uprolling and unrolling interconnected slats (15) of a roller shutter, comprising a winding tube made of a sheet of metal (1) and produced by rolling or bending, which winding tube comprises a contour that differs from the cylindrical shape as well as an eyelet (5) formed out of one of the longitudinal edges (3) of the sheet of metal (1).

8. The winding device according to claim 7, wherein the winding tube, seen over the length thereof, is provided with the eyelet (5) for receiving the slats (15), and wherein the longitudinal edge (3) of the winding tube which faces the eyelet (5) is firmly connected to a pre-determinable section (9) of the eyelet (5).

9. The winding device according to claim 7, wherein the longitudinal edge (3) of the winding tube which faces the eyelet (5) runs linearly under an angle towards the section (9) of the eyelet (5).

10. The winding device according to claim 7, wherein the longitudinal edge (3) is connected to the section (9) of the eyelet (5) by welding (10), especially by laser welding.

11. The winding device according to claim 7, wherein the winding tube encloses a drive axis (11) that is arranged in at least the end portions of the winding tube in an eccentric manner with respect to the same one.
